(19) United States
(12) Patent Application Publication
(10) Pub. No.: US 2026/0284532 A1
(43) Pub. Date: Sep. 24, 2026

(54) METHOD OF OUTPUTTING AUDIO SIGNALS FROM A COMPUTING SYSTEM TO MULTIPLE PERIPHERAL DEVICES

(71) Applicant: Sony Interactive Entertainment Inc., Tokyo (JP)

(72) Inventors: Alan Suganuma Murphy, London (GB); Michael Lee Jones, London (GB); Calum Armstrong, London (GB); Naoise Tobin, London (GB)

(21) Appl. No.: 19/572,416

(22) Filed: Mar. 19, 2026

(30) Foreign Application Priority Data
Mar. 21, 2025 (GB) 2504204.5

(51) Int. Cl. A63F 13/54; A63F 13/285; A63F 13/31

(52) U.S. Cl. CPC A63F 13/54; A63F 13/285; A63F 13/31

(57) ABSTRACT

Disclosed herein is a method of outputting audio signals from a computing system to multiple peripheral devices, the method comprising: detecting a plurality of peripheral devices in a powered-on state, wherein each of the peripheral devices are connected to the computing system and respectively comprise a vibration generating component; identifying which of the peripheral devices are in an idle state; and sending audio signals to the identified peripheral devices.

### CROSS-REFERENCE TO RELATED APPLICATIONS

This application claims priority to United Kingdom Application No. 2504204.5, filed on Mar. 21, 2025, the contents of which are incorporated herein by reference.

### FIELD

The present disclosure relates to outputting audio signals from a computing system to multiple peripheral devices. In particular, the present disclosure includes a method of outputting audio signals from a computing system such as a video game console to multiple peripheral devices to generate surround-sound using the peripheral devices.

### BACKGROUND

Media executed on computing systems, such as a video game being run by a video game console, often have associated audio that can be output from the computing system to improve a user’s experience of the media. This audio is usually output using speakers or wearable headsets that are connected to the computing system.

Modern peripheral devices, such as handheld mobile devices or video game controllers, often comprise physical components that can produce sound via vibrations. These components include speakers and haptic generators, for example.

Handheld mobile devices have been used to output audio associated with media being executed by the devices themselves, for example in the context of a game being played on a mobile phone. In the example of a video game being run by a video game console, video game controllers have been used to output audio associated with the video game whilst the controllers are being used to play the video game. However, these approaches do not provide complex output audio to a user.

It is an object of the disclosure to improve the outputting of audio signals from a computing system to multiple peripheral devices.

### SUMMARY

In a first aspect of the present disclosure there is provided a method of outputting audio signals from a computing system to multiple peripheral devices, comprising: detecting multiple peripheral devices in a powered-on state, wherein each of the peripheral devices are connected to the computing system and respectively include a vibration generating component; identifying which of the peripheral devices are in an idle state; and sending audio signals to the identified peripheral devices. In various examples, only one device in the idle state may be identified.

In this way, idle peripheral devices can be used to output audio corresponding to the audio signals to provide surround-sound. These idle peripheral devices would otherwise not be used in the execution of media by the computing system. The present disclosure can therefore provide more complex output audio, improving the user experience of the media being executed by the computing system.

Peripheral devices in the idle state may be referred to as idle devices or idle peripheral devices herein. In examples, the idle state is an operating mode of the peripheral devices in which control signals provided to the computing system from the devices do not control media being executed by the computing system. For example, an idle state could be a standby mode in which a peripheral device is switched on but user inputs to the device do not result in inputs being provided to the computing system that it is connected to. As another example, a peripheral device in an idle state may be switched on and connected to the computing system, but the device not associated with a profile that can enable it to control media executed by the computing system.

In certain examples, a peripheral device in an idle state may be in an operating mode in which control signals provided to the computing system from the device control media being executed by the computing system, but the peripheral device is not currently being used to control media executed by the computing system. In this case, the peripheral device may have entered the idle state if it had not been used within a predetermined time period. The predetermined time period may be, 30 seconds, 1 minute, or 2 minutes, for example.

The audio signals can correspond to media being executed by computing system and the audio output by the peripheral devices in the idle state corresponds to the audio signals. Audio can be output by the peripheral devices using the vibration generating components. In examples, the peripheral devices can be connected to the computing system by a wired or wireless connection.

In certain implementations, the method includes: controlling the peripheral devices in the idle state to enter an audio mode in which an amount of power consumed by components other than the vibration generating components is reduced.

In this way, the power consumption of other components of the peripheral devices such as screens, user inputs, or other outputs can be reduced to prioritise powering of the vibration generating components. In turn, this will increase the length of the time that a peripheral device can be used to output audio and provide surround-sound in examples in which the devices are battery-powered.

In various examples the method includes: identifying which of the peripheral devices are in an active state; and the step of sending the audio signals to the identified peripheral devices includes sending the audio signals to the peripheral devices in the active state. In various examples, only one active device may be identified.

In this way, active peripheral devices can also be used to output audio corresponding to the audio signals to provide surround-sound in addition to the idle peripheral devices. This therefore provides more complex output audio, improving the user experience of the media being executed by the computing system.

Peripheral devices in the active state may be referred to as active devices or active peripheral devices herein. In examples, the active state is an operating mode of the peripheral devices in which control signals provided to the computing system from the devices control media being executed by the computing system. For example, an active peripheral device can be a peripheral device that has been used to control media executed by the computing system within the predetermined time period. In this example, an active peripheral device may enter the idle state if it is not used within the predetermined time period.

In examples, the audio signals being sent to the active devices preferably correspond to media being executed by computing system and the audio output by the active peripheral devices corresponds to the audio signals. Audio can be output by the peripheral devices using the vibration generating components. In embodiments, the active peripheral devices can also be connected to the computing system by a wired or wireless connection.

In various examples, sending the audio signals to the identified peripheral devices includes: sending audio signals representing different audio channels to different identified peripheral devices or sending audio signals representing different audio channels to different peripheral devices in the idle state or in the active state.

In this way, a more complex surround-sound experience can be created for a user of the computing system using the peripheral devices in the idle state and optionally the active state. In examples, different respective audio channels may be sent to different respective devices, regardless of whether the device is in the idle state or the active state.

As used herein, the term audio channel can be taken to mean a portion of the audio associated with the media being executed by the computing system, or a representation of the audio coming from or going to a single point. For example, the audio associated with the media being executed by the computing system may be divided into left, right, centre, left surround, right surround, and bass. Alternatively, the audio associated with the media being executed by the computing system may be divided by frequency into a bass, mid and/or high channel.

Preferably, the method further includes: receiving a user input; and determining, based on the user input, which audio signals representing the different audio channels are to be sent to a given identified peripheral device. In this way, a user can select which audio channels should be output by a given identified peripheral device, or example to idle devices and optionally active devices.

For example, the user input can indicate that certain audio channels should be output by devices in the idle state, or that only the devices in the idle state should be used to output audio. In examples, the user input may be received at the computing system via a peripheral device in the active state. Alternatively, the user input may be received directly at the computing system.

In alternative examples, sending audio signals representing different audio channels to different identified peripheral devices is carried out based on a predetermined channel specification. In this way, the audio channels that should be output by respective devices in the idle state, and optionally the active state, can be preconfigured.

In various examples, sending audio signals representing different audio channels to different identified peripheral devices includes: sending an audio signal representing a first audio channel to the peripheral devices in the idle state; and sending an audio signal representing a second audio channel to the peripheral devices in the active state.

In this way, the peripheral devices in the idle state and the active state can output different audio channels. In alternative examples, audio signals representing the same audio channels may be sent to the both the devices in the idle state and the active sate so that they each output the same audio channels. In a further alternative example, each peripheral device, active or idle, may be sent a different audio channel.

Preferably, a frequency band of the first audio channel includes lower audio frequencies than the second audio channel. In this way, peripheral devices in the idle state can output a bass frequencies and peripheral devices in the active can output mid and high frequencies. However, in alternative examples, frequency band of the first audio channel includes higher audio frequencies than the second audio channel.

In various examples, the vibration generating components of the peripheral devices includes a speaker and/or a haptic generator. Preferably, the vibration generating components of the peripheral devices in the idle state include a haptic generator and the vibration generating components of the peripheral devices in the active state include a speaker, and the haptic generators of the peripheral devices in the idle state output the first audio channel, and the speakers of the peripheral devices in the active state output the second audio channel. In this way, vibrations produced by the haptic generators of the peripheral devices in the idle state can be used to produce bass frequencies, whereas mid and high frequencies can be produced by speakers of the devices in the active state. In examples, haptic generators and speakers of peripheral devices in the idle state or the active state may produce bass, mid and high frequencies.

In various examples, the method includes: determining respective locations of the identified peripheral devices; wherein sending audio signals representing different audio channels to different identified peripheral devices is carried out based on the determined respective locations of the identified peripheral devices.

In this way, sound localisation effects can be generated. For example, the first audio channel could be sent to peripheral devices closest to the computing system and the second audio channel could be sent to peripheral devices furthest away from the computing system, irrespective of whether the devices are in the idle state or the active state. Preferably, the respective locations of the identified peripheral devices are determined using one or more of: sound-based location tracking; camera-based location tracking; or motion-based location tracking.

In alternative examples, the method includes: signalling to a user to place the peripheral devices in the idle state at respective predetermined locations; and sending audio signals representing different audio channels to different identified peripheral devices in the idle state based on the predetermined location at which a given peripheral device in the idle state is placed. In this way, predetermined sound localisation effects can be realised.

Preferably, the vibration generating components of the peripheral devices in the idle state include a haptic generator and the method includes: signalling to a user to place the identified peripheral devices in the idle state on a surface, such that sound output by the haptic generators of the peripheral devices in the idle state will reverberate. In this way, audio output by peripheral devices, particular bass frequencies can be amplified through the reverberation.

In examples, signalling to a user to place the peripheral device or devices in the idle state on a surface may include the computing system outputting an audio signal instructing a user accordingly, and/or outputting a visual signal accordingly to a screen connected to the computing system.

In various examples, a docking station configured to hold one or more peripheral devices may be provided in connection with the computing system. In such examples, when a peripheral device is placed in the docking station, it may be identified that the docked peripheral device is in the idle state. Conversely, peripheral devices that are not placed in the docking station can be identified as being in the active state. The docked device may be controlled by the computing system to enter the idle state when it is placed in the docking station. In various examples, the docking station may be configured to reverberate vibrations produced by the vibration generating component of a peripheral device. The docking station can be placed at a predetermined location which is optimal for audio output.

In various examples, signalling to a user to place the identified peripheral devices in the idle state on a surface includes: signalling to a user to place the identified peripheral devices in the idle state into a docking station, wherein the docking station is configured to reverberate sound output by the haptic generators of the peripheral devices in the idle state. For example, the docking station may include a bass reflex system, or cavity, which is configured to reverberate sound.

In this way, peripheral devices can be placed in the docking station, which can be positioned at a predetermined location to produce optimal sound reverberation. Audio output by peripheral devices, particular bass frequencies can be amplified when they are placed in the docking station.

In various examples, one or more of the peripheral devices is a docking station configured to hold a further peripheral device, the method including: detecting that the docking station is in a powered-on state, wherein the docking station is connected to the computing system via the held peripheral, and wherein the docking station includes a vibration generating component; identifying that the held peripheral device is in an idle state; and sending audio signals to the held peripheral device, such that the vibration generating component of the docking station can output audio corresponding to the audio signals received via the held peripheral device.

In this way, as the held or docked peripheral device is connected the computing system, the docking station can use it as a proxy to receive audio signals to be output. Furthermore, higher quality audio can be output through the vibration generating component of the docking station. In such an example, it may not be necessary to output audio from the held peripheral device.

The docking station and its vibration generating component (e.g. a speaker) can be actively powered when in the powered-on state. Preferably, the docking station is configured to charge a peripheral device that is docked therein. In this example, when a peripheral device is placed in the docking station and optionally is being charged, it may be identified that the docked peripheral device is in the idle state. Furthermore, it may be detected that the docking station is in the powered-on state when a peripheral device is held, or docked, therein.

The vibration generating component of the docking station may be connected to the held peripheral device through a wired or wireless connection. This is so that audio data received by the held peripheral device can be relayed to the vibration generating component of the docking station. For example, the vibration generating component of the docking station could be connected to the held peripheral device via a lead plugged into an audio output port. In various examples, the docking station may be configured to hold, and optionally charge, one or more further peripheral devices.

In alternative examples, the vibration generating components of the peripheral devices in the idle state include a removable haptic generator, the method including: signalling to a user to remove the removable haptic generator from the identified peripheral devices in the idle state and place the removable haptic generator on a surface, such that sound output by the removable haptic generator of the identified peripheral devices in the idle state will reverberate. In this way, audio output by peripheral devices, particular bass frequencies can be amplified through the reverberation.

In various examples, the computing system includes a video game console, a personal computing device or a handheld mobile device.

In a second aspect there is provided a method of outputting audio from a peripheral device, including: receiving audio signals from a computing system at a peripheral device connected to the computing system and including a vibration generating component, according to the method of any of the preceding claims; and outputting audio corresponding to the received audio signals using the vibration generating component.

The peripheral devices described herein preferably include a detector and a processor. The detector can be configured to detect audio signals sent from the computing system and forward these signals to the processor. The processor can interpret the audio signals and instruct the vibration generating component to vibrate accordingly to produce output audio corresponding to the received audio signals.

Preferably, the vibration generating component includes a speaker and/or a haptic generator. In various examples, the vibration generating component of the peripheral device includes a removable haptic generator.

In a third aspect there is provided a method of outputting audio from multiple peripheral devices, wherein audio is output from each of the peripheral devices according to the second aspect, thereby generating surround-sound using the peripheral devices in the idle state.

Preferably, one or more of the peripheral devices are speakers. In this way, speakers can be used in addition to peripheral devices to output audio according to the received audio signals and generate surround sound. In examples, the speakers may be connected to the computing system via a wired or wireless connection.

In various examples, the peripheral device or devices include a handheld mobile device and/or a video game controller.

In a fourth aspect there is provided a computer program product including instructions thereon, that when executed by a processor, cause the processor to execute the method of any of the first, second or third aspects.

In a fifth aspect there is provided a computing system including processor and a memory, the memory including instructions thereon which, when executed by a processor, cause the processor to execute the method of the first aspect.

In a sixth aspect there is provided a peripheral device including a vibration generating component and circuitry coupled to the vibration generating component, the circuitry being configured to perform the method of the second aspect.

In a seventh aspect there is provided a system for outputting audio, including: a computing system according to the fifth aspect; and multiple peripheral devices according to the sixth aspect.

Preferably, the system includes a docking station configured to hold one or more peripheral devices according to the sixth aspect and configured to communicate with the computing system according to the fifth aspect, wherein the docking station is configured to indicate to the computing system that a peripheral device has been received therein, and wherein the docking station is configured to wherein the docking station is configured to reverberate vibrations output by the vibration generating components of the peripheral devices. For example, the docking station may include a bass reflex system, or cavity, which is configured to reverberate sound. This may enhance the reproduction of bass frequencies produced by haptic generators of the peripheral devices. For example, the docking station body may be hollow and have an elongate port or vent cut thereinto. Sound can therefore reverberate within the opening produced by the port or vent. The docking station can be placed at a predetermined location which is optimal for audio output.

Alternatively, the system may include a docking station configured to hold one or more further peripheral devices according to the sixth aspect and configured to communicate with the computing system according to the fifth aspect via a held peripheral device, wherein the docking station includes a vibration generating component configured to receive audio signals from the computing system via the held peripheral device

The docking station and its vibration generating component can be actively powered. The vibration generating component of the docking station may be connected to held peripheral device through a wired or wireless connection, for example.

Preferably, a peripheral device is identified to be in the idle state when it is received in the docking station. In such examples, when a peripheral device is placed in the docking station, it may be identified to the computing system that the device has been docked and that it is in the idle state. Conversely, peripheral devices that are not placed in the docking station can be identified as being in the active state. Alternatively, the docked device may be controlled by the computing system to enter the idle state once it has been identified that it is has been received in the docking station. The docking station may be configured to charge each of the one or more further peripheral devices held therein.

### BRIEF DESCRIPTION OF DRAWINGS

Embodiments will now be described, by way of example, by reference to the drawings, in which:

FIG. 1 is a diagram of an example system for outputting audio ;

FIG. 2 is a flow diagram of an example method of outputting audio signals from a computing system to multiple peripheral devices ; and

FIG. 3 is a flow diagram of an example method of outputting audio signals from a computing system to multiple peripheral devices .

### DETAILED DESCRIPTION

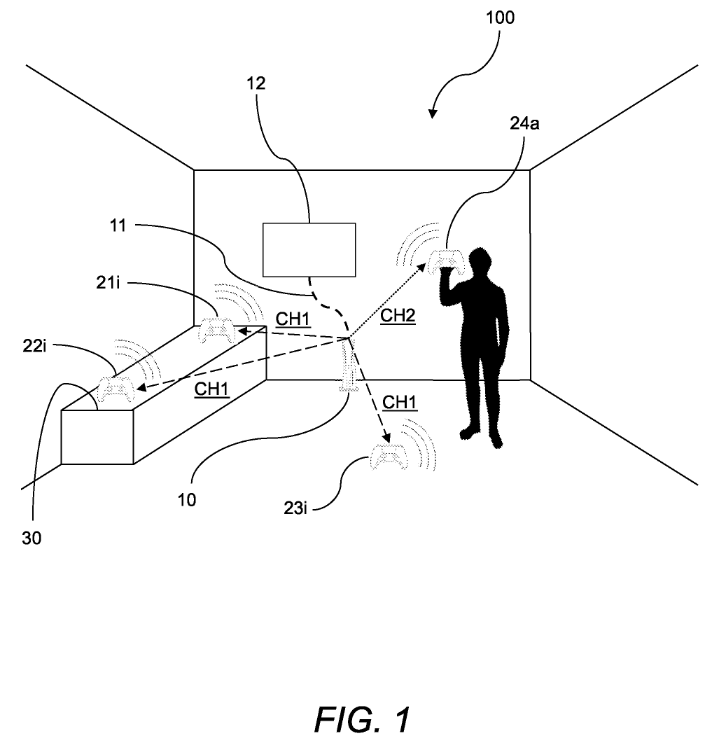

FIG. 1 is a diagram of a system 100 for outputting audio. The system 100 includes a video game console 10, which is connected to a display 12 via a wired connection 11. The video game console 10 is configured to output video data associated with a video game being run on a console to the display 12 via the wired connection 11. The display 12 displays video according to the received video data.

The system 100 also includes four video game controllers 21i, 22i, 23i and 24a as peripheral devices to the video game console 10. Each of the controllers 21i, 22i, 23i and 24a are powered on and are wirelessly connected to the console 10 so that signals including data can be exchanged between them. Controllers 21i, 22i, 23i are in an idle state and are not currently being used to play the video game being run on the console 10, as depicted in FIG. 1. The idle controllers 21i, 22i are situated on a surface 30 and the idle controller 23i is situated on the floor, all of which being in the vicinity of the console 10. The controller 24a is in an active state and is currently being used by a user to play the video game being run on the console 10, as depicted in FIG. 1. The active controller 24a is being held by a user in the vicinity of the console 10.

As shown in FIG. 1, the console 10 is outputting audio signals CH1, CH2 including audio data representing two different audio channels (channel 1 and channel 2 respectively). The audio channels CH1, CH2 represent different frequency bands of audio associated with the video game being run on a console 10. CH1 is being output to controllers 21i, 22i, 23i in the idle state and CH2 is being output to controller 24a in the active state. Each of the controllers 21i, 22i, 23i and 24a outputs audio corresponding to the audio signal that it receives using a speaker and/or a haptic generator. Surround-sound is therefore generated using idle controllers 21i, 22i, 23i and the active controller 24a in the system 100.

Each of the controllers 21i, 22i, 23i and 24a includes a detector and a processor. The detectors are configured to detect audio signals CH1, CH2 sent from the console 10 and to forward these signals to the processor. The processor interprets the audio signals CH1, CH2 and instructs the speakers and haptic generators to vibrate accordingly to produce output audio.

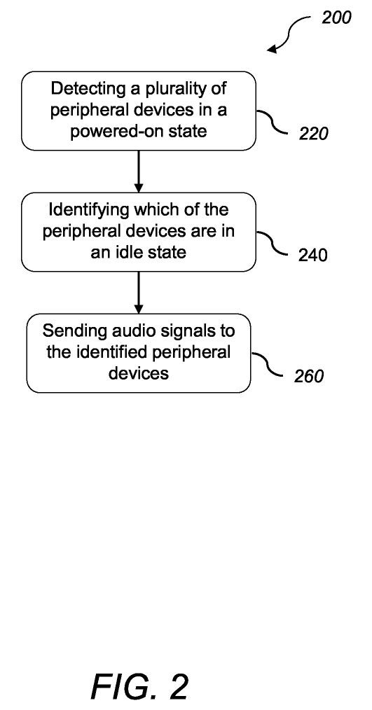

FIG. 2 is a flow diagram of a method 200 of outputting audio signals from a computing system to multiple peripheral devices in another example. The method 200 includes steps 220, 240 and 260. Respectively, these steps generally involve detecting multiple peripheral devices in a powered-on state; identifying which of the peripheral devices are in an idle state; and sending audio signals to the identified peripheral devices.

For example, with reference to the example according to FIG. 1, Step 220 includes detecting that the video game controllers 21i, 22i, 23i and 24a are in a powered-on state. Step 240 includes identifying which of the controllers 21i, 22i, 23i and 24a are in an idle state. In the example according to FIG. 1, controllers 21i, 22i, 23i are in an idle state as they are not being used to play the video game. Step 260 includes sending audio signals CH1 to the controllers 21i, 22i, 23i so that the idle controllers can output audio and generate surround-sound.

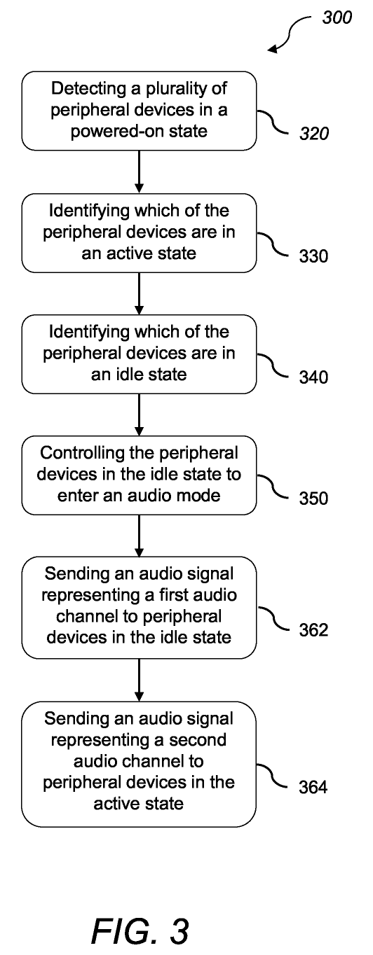

FIG. 3 is a flow diagram of a method 300 of outputting audio signals from a computing system to multiple peripheral devices in another example. The method 300 includes steps 320, 330, 340, 350, 362 and 364. Respectively, these steps generally involve detecting multiple peripheral devices in a powered-on state; identifying which of the peripheral devices are in an active state; identifying which of the peripheral devices are in an idle state; controlling the peripheral devices in the idle state to enter an audio mode; sending an audio signal representing a first audio channel to peripheral devices in the idle state; and sending an audio signal representing a second audio channel to peripheral devices in the active state.

Specific aspects of the method 300 will now be described by reference to the example according to FIG. 1.

Step 320 includes detecting multiple video game controllers in a powered-on state. In the present example, each of the controllers 21i, 22i, 23i and 24a in a powered-on state. The video game console 10 detects that the video game controllers 21i, 22i, 23i and 24a in a powered-on state by sending a signal to each of the controllers 21i, 22i, 23i and 24a and detecting a response from each of the controllers 21i, 22i, 23i and 24a indicating that they are powered on. If no such response is received from a given controller, then it is determined that that controller is not powered on.

In various examples, each controller 21i, 22i, 23i and 24a may be associated with a unique identifier so that the console 10 is able to identify each controller when the two are in communication with each other. Equally, each signal sent by a particular controller may includes a unique signature identifying that controller.

At step 330, it is identified which of the controllers 21i, 22i, 23i and 24a are in an active state. The controller 24a is the only controller in an active state in this example as it is the only controller being used to play the video game being run on the console 10. The console 10 identifies that the controller 24a is in an active state as it is continuously receiving input signals from the controller 24a associated with gameplay. This indicates that the user is using the controller 24a to play the video game.

At step 340, it is identified which of the controllers 21i, 22i, 23i and 24a are in an idle state. It has already been identified that the controller 24a is in an active state. The console 10 identifies that the controllers 21i, 22i, 23i are in an idle state by checking whether each of the controllers are signed into a user profile that can be used to play the video game, or by checking whether a user input has been received within a predetermined time period. If neither of these criteria are satisfied, then the controller is identified is being in an idle state. From example, if a particular controller is not signed into a user profile that can be used to play the video game then it is not usable to play the video game and is idle. Additionally, if a user input has not been received at the controller for a period exceeding a predetermined cutoff period, then it can be assumed that the controller is no longer being used to play the video game and it is therefore idle.

In examples, a docking station configured to hold one or more peripheral devices may be provided in communication with the computing system. When a peripheral device is placed in the docking station, it can be signalled to the computing system that it has been received and that the docked peripheral device is in the idle state. Conversely, peripheral devices that are not placed in the docking station can be identified as being in the active state. Alternatively, a peripheral device may be controlled to enter the idle state when the computing system recognises that it has been placed in the docking station.

At step 350, controllers 21i, 22i, 23i are controlled to enter an audio mode by the console 10. The audio mode is a mode in which the speakers and haptic generators of the controllers 21i, 22i, 23i, as they are not needed to send signals to the console 10 to control the video game being run. The console 10 controls the controllers 21i, 22i, 23i to enter the audio mode by sending a signal to each of the controllers instructing their respective processors to stop routing power to components other than the speakers and the haptic generators.

At step 362, audio signals CH1 representing a first audio channel are sent to idle controllers 21i, 22i, 23i. At step 364, an audio signal CH2 representing a second audio channel is sent to active controller 24a. Different audio signals CH1, CH2 are therefore sent to idle and active controllers respectively. In this example, CH1 includes bass frequencies and CH2 includes mid and high frequencies. Audio corresponding to CH1 is output using the haptic generators of the idle controllers 21i, 22i, 23i, whereas audio corresponding to CH2 is output using the speaker of active controller 24a.

In this example, the audio signals CH1, CH2 are sent to the idle and active controllers respectively using a predetermined channel specification. The channel specification being that a lower-frequency band channel is sent to idle controllers and a higher-frequency band channel is sent to the active controllers. In alternative examples, a user may select which channels are sent to which of the controllers 21i, 22i, 23i and 24a by providing an input accordingly to the console 10.

Optional extensions to the methods 200 and/or 300 will now be described by reference to the example according to FIG. 1.

In various examples, audio signals representing different audio channels are sent to different peripheral devices in the idle or active states based on determined respective locations of the devices. The respective locations of the devices can be determined by the computing device using any of sound-based location tracking; camera-based location tracking; or motion-based location tracking.

For example, instead of sending signals CH1 to the idle controllers 21i, 22i, 23i and the signal CH2 to the active controller 24a as shown in FIG. 1. Different audio signals representing different audio channels may be sent to each of the devices 21i, 22i, 23i and 24a based on their location. A low frequency range channel could be sent to devices 21i and 24a as they are located in close proximity to the console 10, whereas a high frequency range channel could be sent to devices 22i and 23i as these are located further away from the console 10. Alternatively, a left channel could be sent to devices 22i and 23i, and a right channel could be sent to devices 21i and 24a to provide a stereo effect.

The console 10 is able to determine the respective locations of each of the devices 21i, 22i, 23i and 24a using sound-based location tracking; camera-based location tracking; or motion-based location tracking.

In an alternative optional example, a user is signalled to place peripheral devices in the idle state at respective predetermined locations; and audio signals representing different audio channels are sent to different identified peripheral devices based on the predetermined location at which a given peripheral device in the idle state is placed.

For example, the user depicted in FIG. 1 could be signalled by the console 10, using either an audible cue or a visual clue displayed on the display 12, to place the idle devices 21i, 22i, 23i at the locations depicted in FIG. 1. Audio signals representing different audio channels can then be sent to each of the idle devices 21i, 22i, 23i respectively based on the respective predetermined locations that each of the idle devices 21i, 22i, 23i are placed at, instead of each of the idle devices 21i, 22i, 23i receiving the same audio signal CH1.

In a further optional extension to the methods 200 and/or 300, a user could be signalled to place the peripheral device or devices in the idle state on a surface, such that sound output by the haptic generator of the peripheral device in the idle state will reverberate.

For example, the user depicted in FIG. 1 could be signalled by the console 10, using either an audible cue or a visual clue displayed on the display 12, to place the idle devices 21i and 22i on the surface depicted in FIG. 1, as opposed to on floor such like device 23i. The sound output by devices 21i and 22i will therefore reverberate more greatly in comparison to the sound output by device 23i.

In examples in which a docking station is provided, a user could be signalled to place the identified peripheral devices in the idle state into the docking station. The docking station can include, a bass reflex system, or cavity, which is configured to reverberate bass produced by the haptic generator of the peripheral device. Alternatively, the docking station may include a vibration generating component that is connected to a docked peripheral device by a wired or wireless connection. In this way, the vibration generating component can receive audio signals from the computing system via the docked peripheral device and output audio accordingly.

Alternatively, each of the vibration generating components of the peripheral devices could include a removable haptic generator. The user could be signalled to remove the removable haptic generator from the peripheral device or devices in the idle state and place the removable haptic generator on a surface, such that sound output by the removable haptic generator of the peripheral device in the idle state will reverberate.

For example, the user depicted in FIG. 1 could be signalled by the console 10, using either an audible cue or a visual clue displayed on the display 12, to remove the removable haptic generators from the idle devices 21i, 22i, 23i and place these on the surface depicted in FIG. 1, as opposed to placing the devices 21i and 22i themselves on the surface. The sound output by removable haptic generators of devices 21i, 22i, 23i will therefore reverberate.

1. A method of outputting audio signals from a computing system to a plurality of peripheral devices, comprising:
detecting a plurality of peripheral devices in a powered-on state, wherein each of the peripheral devices are connected to the computing system and respectively comprise a vibration generating component;
identifying which of the peripheral devices are in an idle state; and
sending audio signals to the identified peripheral devices.

2. The method of claim 1, comprising:
controlling the peripheral devices in the idle state to enter an audio mode in which an amount of power consumed by components other than the vibration generating components is reduced.

3. The method of claim 1, comprising:
identifying which of the peripheral devices are in an active state; and
wherein the step of sending the audio signals to the identified peripheral devices comprises sending the audio signals to the peripheral devices in the active state.

4. The method of claim 1, wherein sending the audio signals to the identified peripheral devices comprises:
sending audio signals representing different audio channels to different identified peripheral devices.

5. The method of claim 4, comprising:
receiving a user input; and
determining, based on the user input, which audio signals representing the different audio channels are to be sent to a given identified peripheral device.

6. The method of claim 4, wherein:
sending audio signals representing different audio channels to different identified peripheral devices is carried out based on a predetermined channel specification.

7. The method of claim 4, wherein sending audio signals representing different audio channels to different identified peripheral devices comprises:
sending an audio signal representing a first audio channel to the peripheral devices in the idle state; and
sending an audio signal representing a second audio channel to the peripheral devices in the active state.

8. The method of claim 7, wherein a frequency band of the first audio channel comprises lower audio frequencies than the second audio channel.

9. The method of claim 1, wherein the vibration generating components of the peripheral devices comprises a speaker and/or a haptic generator.

10. The method of claim 1, wherein the vibration generating components of the peripheral devices in the idle state comprise a haptic generator and the vibration generating components of the peripheral devices in the active state comprise a speaker, and wherein the haptic generators of the peripheral devices in the idle state output the first audio channel, and the speakers of the peripheral devices in the active state output the second audio channel.

11. The method of claim 4, comprising:
determining respective locations of the identified peripheral devices;
wherein sending audio signals representing different audio channels to different identified peripheral devices is carried out based on the determined respective locations of the identified peripheral devices.

12. The method of claim 11, wherein the respective locations of the identified peripheral devices are determined using one or more of:
sound-based location tracking;
camera-based location tracking; or
motion-based location tracking.

13. The method of claim 4, comprising:
signalling to a user to place the peripheral devices in the idle state at respective predetermined locations; and
sending audio signals representing different audio channels to different identified peripheral devices in the idle state based on the predetermined location at which a given peripheral device in the idle state is placed.

14. The method of claim 1, wherein the vibration generating components of the peripheral devices in the idle state comprise a haptic generator, comprising:
signalling to a user to place the identified peripheral devices in the idle state on a surface, such that sound output by the haptic generators of the peripheral devices in the idle state will reverberate.

15. The method of claim 1, wherein one or more of the peripheral devices is a docking station configured to hold a further peripheral device, the comprising:
detecting that the docking station is in a powered-on state, wherein the docking station is connected to the computing system via the held peripheral device, and wherein the docking station comprises a vibration generating component;
identifying that the held peripheral device is in an idle state; and
sending audio signals to the held peripheral device, such that the vibration generating component of the docking station can output audio corresponding to the audio signals received via the held peripheral device.

16. The method of claim 1, wherein the vibration generating components of the peripheral devices in the idle state comprise a removable haptic generator, comprising:
signalling to a user to remove the removable haptic generator from the identified peripheral devices in the idle state and place the removable haptic generator on a surface, such that sound output by the removable haptic generator of the identified peripheral devices in the idle state will reverberate.

17. A method of outputting audio from a peripheral device, comprising:
receiving audio signals from a computing system at a peripheral device connected to the computing system and comprising a vibration generating component, according to the method of claim 1; and
outputting audio corresponding to the received audio signals using the vibration generating component.

18. The method of claim 17, wherein audio is output from each of the peripheral devices according to the method of claim 17, thereby generating surround-sound using the peripheral devices in the idle state.

19. A system comprising:
a plurality of peripheral devices, wherein each peripheral device comprises a vibration generating component and circuitry coupled to the vibration generating component; and
a computing system comprising processor and a memory, the memory comprising instructions thereon which, when executed by a processor, cause the processor to: detect a plurality of peripheral devices in a powered-on state, wherein each of the peripheral devices are connected to the computing system and respectively comprise a vibration generating component;
identify which of the peripheral devices are in an idle state; and
send audio signals to the identified peripheral devices.

20. The system of claim 19, further comprising a docking station configured to hold one or more further peripheral devices and configured to communicate with the computing system via a held peripheral device, wherein the docking station comprises a vibration generating component configured to receive audio signals from the computing system via the held peripheral device, wherein a peripheral device is identified to be in the idle state when it is received in the docking station.
